(19) United States
(12) Patent Application Publication
(10) Pub. No.: US 2005/0015372 A1
(43) Pub. Date: Jan. 20, 2005

(54) Method for data processing in a multi-processor data processing system and a corresponding data processing system

(76) Inventors: Josephus Theodorus Van Eijndhoven, Eindhoven (NL); Evert-Jan Daniel Pol, Eindhoven (NL); Martijn Johan Rutten, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/498,448

(22) PCT Filed: Dec. 5, 2002
(86) PCT No.: PCT/IB02/05244

(30) Foreign Application Priority Data
Dec. 14, 2001 (EP) 01204884.9

(51) Int. Cl. G06F 17/30; G06F 7/00

(52) U.S. Cl. 707/9

(57) ABSTRACT

The invention is based on the idea to separate a synchronisation operation from reading and writing operations. Therefore, a method for data processing in the data processing system is provided, wherein said data processing system comprises a first and at least a second processor for processing streams of data objects, wherein said first processor passes data objects from a stream of data objects to the second processor. Said data processing system further comprises at least one memory for storing and retrieving data objects, wherein a shared access of said first and second processors is provided. The processors perform a read operations and/or write operations in order to exchange data objects with his said memory. Said processors further perform inquiry operations and/or commit operations in order to synchronise a data object transfer between tasks which are executed by said processors. Said inquiry operations and said commit operations are performed independently of said read operations and said write operations by said processors.

The invention relates to a method for data processing in a multi-processor data processing system and a corresponding data processing system having multiple processors.

A heterogeneous multiprocessor architecture for high performance, data-dependent media processing e.g. for high-definition MPEG decoding is known. Media processing applications can be specified as a set of concurrently executing tasks that exchange information solely by unidirectional streams of data. G. Kahn introduced a formal model of such applications already in 1974, ‘The Semantics of a Simple Language for Parallel Programming’, Proc. of the IFIP congress 74, August 5-10, Stockholm, Sweden, North-Holland publ. Co, 1974, pp. 471-475 followed by an operational description by Kahn and MacQueen in 1977, ‘Co-routines and Networks of Parallel Programming’, Information Processing 77, B. Gilchhirst (Ed.), North-Holland publ., 1977, pp 993-998. This formal model is now commonly referred to as a Kahn Process Network.

An application is known as a set of concurrently executable tasks. Information can only be exchanged between tasks by unidirectional streams of data. Tasks should communicate only deterministically by means of a read and write action regarding predefined data streams. The data streams are buffered on the basis of a FIFO behaviour. Due to the buffering two tasks communicating through a stream do not have to synchronise on individual read or write actions.

In stream processing, successive operations on a stream of data are performed by different processors. For example a first stream might consist of pixel values of an image, that are processed by a first processor to produce a second stream of blocks of DCT (Discrete Cosine Transformation) coefficients of 8×8 blocks of pixels. A second processor might process the blocks of DCT coefficients to produce a stream of blocks of selected and compressed coefficients for each block of DCT coefficients.

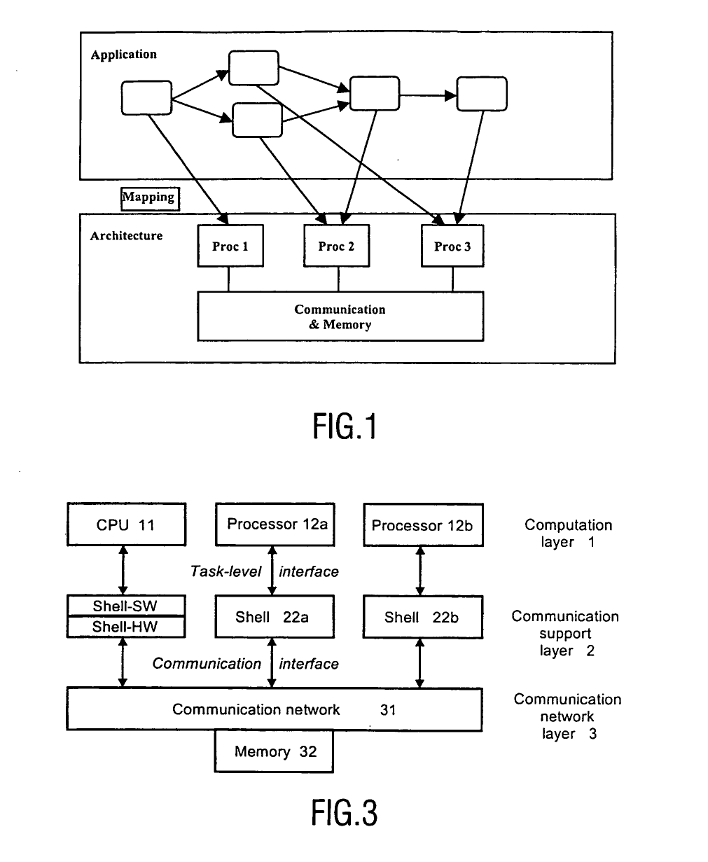

FIG. 1 shows a illustration of the mapping of an application to a processor as known from the prior art. In order to realise data stream processing a number of processors are provided, each capable of performing a particular operation repeatedly, each time using data from a next data object from a stream of data objects and/or producing a next data object in such a stream. The streams pass from one processor to another, so that the stream produced by a first processor can be processed by a second processor and so on. One mechanism of passing data from a first to a second processor is by writing the data blocks produced by the first processor into the memory.

The data streams in the network are buffered. Each buffer is realised as a FIFO, with precisely one writer and one or more readers. Due to this buffering, the writer and readers do not need to mutually synchronize individual read and write actions on the channel. Reading from a channel with insufficient data available causes the reading task to stall. The processors can be dedicated hardware function units which are only weakly programmable. All processors run in parallel and execute their own thread of control. Together they execute a Kahn-style application, where each task is mapped to a single processor. The processors allow multi-tasking, i.e., multiple Kahn tasks can be mapped onto a single processor.

It is an object of the invention to improve the operation of a Kahn-style data processing system.

This object is solved by a method for processing data in the data processing system according to claim 1 and the corresponding data processing system according to claim 11.

The invention is based on the idea to separate a synchronisation operation from reading and writing operations. Therefore, a method for data processing in the data processing system is provided, wherein said data processing system comprises a first and at least a second processor for processing streams of data objects, wherein said first processor passes data objects from a stream of data objects to the second processor. Said data processing system further comprises at least one memory for storing and retrieving data objects, wherein a shared access of said first and second processors is provided. The processors perform a read operations and/or write operations in order to exchange data objects with his said memory. Said processors further perform inquiry operations and/or commit operations in order to synchronise a data object transfer between tasks which are executed by said processors. Said inquiry operations and said commit operations are performed independently of said read operations and said write operations by said processors.

This has the advantage that the separation of synchronisation operations and read/or write operations lead to the more efficient implementation then a usually provided combination thereof. Furthermore, a single synchronisation operation can cover a series of read or write operations at once, reducing the frequency of synchronisation operations.

In a further aspect of the invention said inquiry operations are executed by one of said second processors to request the right to access a group of data objects in said memory, wherein said group of data object is produced or consumed in said memory by a series of read/write operations by said processors. Moreover, said commit operations are executed by one of said second processors to transfer the right to access said group of data objects to another of said second processors.

In a preferred aspect of the invention said read/write operations enable said second processors to randomly access locations within one of said groups of data elements in said memory. Providing a random access in one group of data objects in the said memory generates several interesting opportunities like out-of-order processing of data and/or temporary storage of intermediate data by read and write memory access.

In a further preferred aspect of the invention, the actual task state of the partial processing of the group of data objects is discarded and commit operations on the partial group of data object are prevented after the task has been interrupted. This allows to interrupt a task while avoiding the costs of saving the actual state of the task.

In still a further preferred aspect of the invention the processor restarts the processing of the group of data object after resumption of the interrupted task, whereby previously processing results on said group of data objects are discarded. This allows to restart the processing of the complete group of data objects of the interrupted task while avoiding state restore costs.

In a further aspect of the invention a third processor receives the right to access a group of data objects from said first processor. Thereafter, it performs read and/or write operations on said group of data objects, and finally transfers the right of access to said second processor, without copying said group of data objects to another location in shared memory. This allows to correct or replace single data objects.

The invention also relates to a data processing system comprising a first and at least a second processor for processing streams of data objects, said first processor being arranged to pass data objects from a stream of data objects to the second processor; and at least one memory for storing and retrieving data objects, wherein a shared access for said first and said second processors is provided, said processors being adopted to perform read operations and/or write operations to exchange data objects with said memory and said processors being adopted to perform inquiry operations and/or commit operations to synchronise data object transfers between tasks which are executed by said processors, wherein said processors being adopted to perform said inquiry operations and said commit operations independently of said read operations and said write operations.

Further embodiments of the invention are described in the dependent claims.

These and other aspects of the invention are described in more detail with reference to the drawings; the figures showing:

FIG. 1 an illustration of the mapping of an application to a processor according to the prior art;

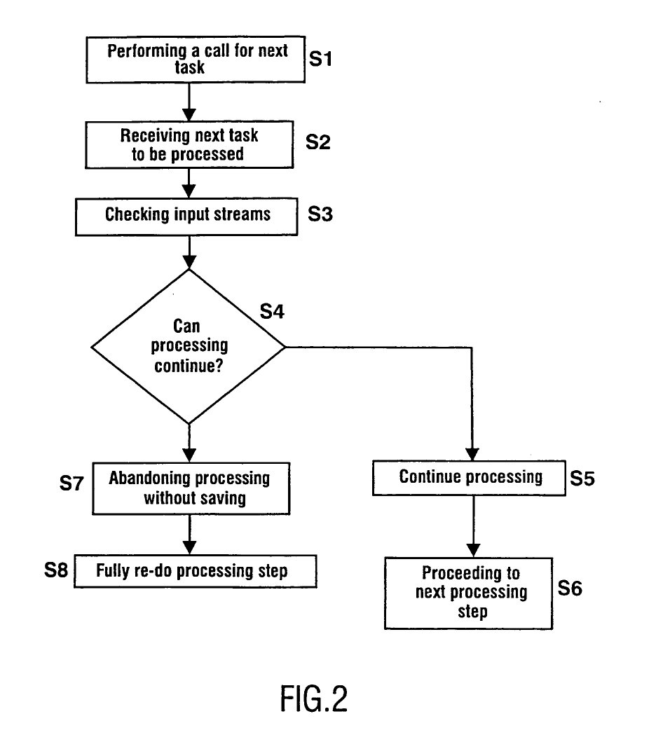

FIG. 2a flow chart the principal processing of a processor;

FIG. 3 a schematic block diagram of an architecture of a stream based processing system according to a second embodiment;

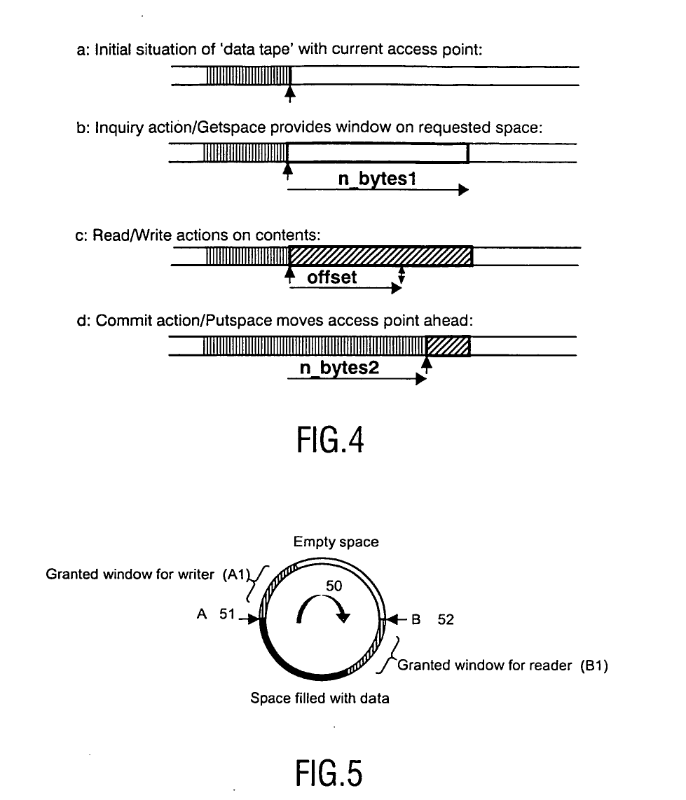

FIG. 4 an illustration of the synchronising operation and an I/O operation in the system of FIG. 3;

FIG. 5 an illustration of a cyclic FIFO memory;

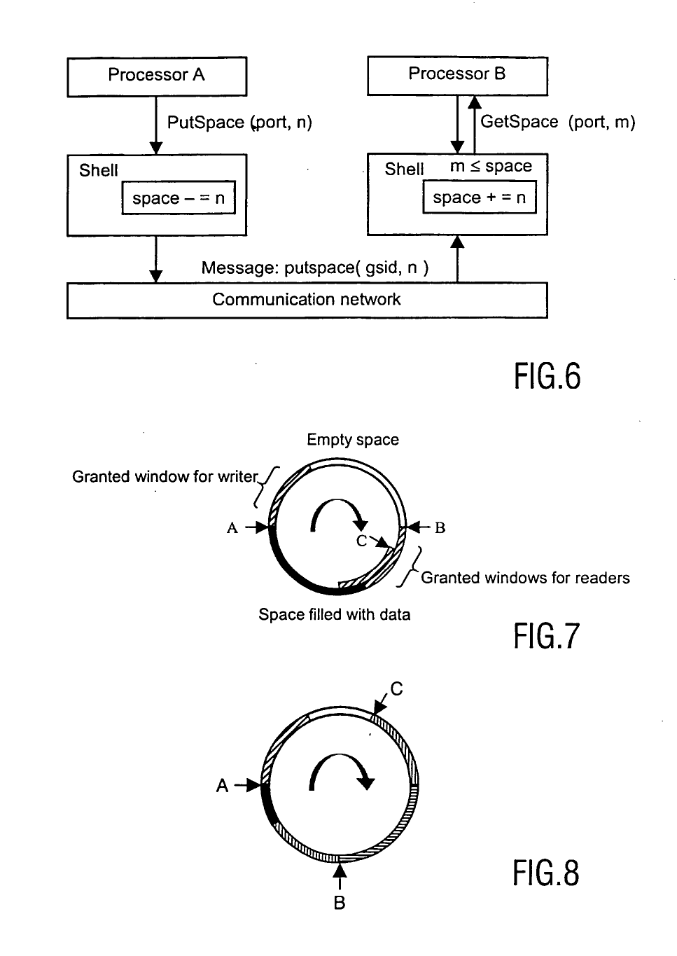

FIG. 6 a mechanism of updating local space values in each shell according to FIG. 3;

FIG. 7 an illustration of the FIFO buffer with a single writer and multiple readers; and

FIG. 8 a finite memory buffer implementation for a three-station stream.

The preferred embodiment of the invention refers to a multi-processor stream-based data processing system preferably comprising the CPU and several processors or coprocessors. The CPU passes data objects from stream of data objects to one of the processors. The CPU and the processors are coupled to at least one memory via a bus. The memory is used by the CPU and the processors for storing and retrieving data objects, wherein the CPU and the processors have shared access to the memory.

The processors perform a read operations and/or write operations in order to exchange data objects with his said memory. Said processors further perform inquiry operations and/or commit operations in order to synchronise a data object transfer between tasks which are executed by said processors. Said inquiry operations and said commit operations are performed independently of said read operations and said write operations by said processors.

The synchronisation operations as described above can be separated into inquiry operations and commit operations. An inquiry operation informs the processor about the availability of data objects for subsequent read operation or the availability of room for subsequent write operation, i.e. the this can also be realised by get_data operations and get_room operations, respectively. After the processor is notified of the available window or the available group of data it can freely access the available window or group of data objects in the buffer anyway it likes. Once the processor-has performed the necessarily processing on the group of data objects or at least on a part of said data objects in said group of data objects or said access window, the processor can issue the commit signal to another processor indicating that data or room is newly available in the memory using and put_data or put_room operations, respectively.

However, in the preferred embodiment these four synchronisation operations do not impose any difference between the processing of the data and the room operations. Therefore, it is advantageous to summarise these operations into the single space operations leaving just two operations for synchronisation, namely get_space and put_space for inquiry and commit, respectively.

The processors explicitly decides on the time instances during a running task at which said running task can be interrupted. The processors can continue up to a point where no or merely a restricted amount of processing resources, like enough incoming data, sufficient available space in the buffer memory or the like, are available to the processors. These points represents the best opportunities for the processors to initiate task switching. The initiation of task switching is performed by the processor by issuing a call for a task to be processed next. The intervals between such calls for a next task from the processor can be defined as processing steps. A processing step may include reading one or more packets or groups of data, performing some operations on the acquired data and writing one or more packets or groups of data.

The concept of reading and writing packets of groups of data is not defined or enforced by the overall system architecture. The notion of packets or groups of data is not visible at the level of the generic infrastructure of the system architecture. The data transport operations, i.e. the reading and writing of data from/into the buffer memory, and the synchronisation operation, i.e. the signalling of the actual consumption of data between the reader and writer for purposes of buffer management, are designed to operate on unformatted byte streams. The notion of packets or groups of data emerges only in the next layer of functionality in the system architecture, i.e. inside the processors which actually perform the media processing.

Each task running on the processor can be modelled as a repetition of processing steps, wherein each processing step attempts to process a packet or group of data. Before performing such processing step the task interacts with a task scheduler in said data processing system in order to determine with which task the processor is supposed to continue and to provide explicit task switching moment.

In FIG. 2 a flow chart of a general processing of the processor is shown. In step S1 the processor performs a call for the next task directed to the task scheduler, in order to determine with which task it is supposed to continue. In step S2, the processor receives from the task scheduler the respective information about the next task to be processed. Thereafter, in step S3 the processing continues with checking input streams belonging to the associated task to be processed next in order to decide whether sufficient data or other processing resources are available to perform the requested processing. This initial investigation may involve attempts to read some partial input and also to decode packet headers. If it is determined in step S4 that the processing can continue since all necessary processing resources are at hand, the flow jumps to step S5 and the respective processor continues with processing the current task. After the processor has finished this processing in step S6 the flow will jump to the next processing step and the above-mentioned steps will be repeated.

However, if in step S4 it is determined that the processor can not continue with the processing of the current task, i.e. it can not complete the current processing step, due to insufficient processing resources like a lack of data in one of the input streams, the flow will be forwarded to step S7 and all results of the partial processing done so far will be discarded without any state saving, i.e. without any saving of the partial processing results processed so far in this processing step. The partial processing may include some synchronisation calls, data read operations, or some processing on the acquired data. Thereafter, in step S8 the flow will be directed to restart and fully re-do the unfinished processing step at a later stage. However, abandoning the current task and discarding the partial processing results will only be possible as long as the current task did not commit any of its stream actions by sending the synchronisation message.

Especially in function-specific hardware processors removing the necessity for support for intermediate state saving and restoring it can simplify their design and reduce their acquired silicon area.

FIG. 3 shows a processing system for processing streams of data objects according to a second embodiment of the invention. The system can be divided into different layers, namely a computation layer 1, a communication support layer 2 and a communication network layer 3. The computation layer 1 includes a CPU 11, and two processors 12a, 12b. This is merely by way of example, obviously more processors may be included into the system. The communication support layer 2 comprises a shell 21 associated to the CPU 11 and shells 22a, 22b associated to the processors 12a, 12b, respectively. The communication network layer 3 comprises a communication network 31 and a memory 32.

The processors 12a, 12b are preferably dedicated processor; each being specialised to perform a limited range of stream processing. Each processor is arranged to apply the same processing operation repeatedly to successive data objects of a stream. The processors 12a, 12b may each perform a different task or function, e.g. variable length decoding, run-length decoding, motion compensation, image scaling or performing a DCT transformation. In operation each processor 12a, 12b executes operations on one or more data streams. The operations may involve e.g. receiving a stream and generating another stream or receiving a stream without generating a new stream or generating a stream without receiving a stream or modifying a received stream. The processors 12a, 12b are able to process data streams generated by other processors 12b, 12a or by the CPU 11 or even streams that have generated themselves. A stream comprises a succession of data objects which are transferred from and to the processors 12a, 12b via said memory 32.

The shells 22a, 22b comprise a first interface towards the communication network layer being a communication layer. This layer is uniform or generic for all the shells. Furthermore the shells 22a, 22b comprise a second interface towards the processor 12a, 12b to which the shells 22a, 22b are associated to, respectively. The second interface is a task-level interface and is customised towards the associated processor 12a, 12b in order to be able to handle the specific needs of said processor 12a, 12b. Accordingly, the shells 22a, 22b have a processor-specific interface as the second interface but the overall architecture of the shells is generic and uniform for all processors in order to facilitate the re-use of the shells in the overall system architecture, while allowing the parameterisation and adoption for specific applications.

The shell 22a, 22b comprise a reading/writing unit for data transport, a synchronisation unit and a task switching unit. These three units communicate with the associated processor on a master/slave basis, wherein the processor acts as master. Accordingly, the respective three unit are initialised by a request from the processor. Preferably, the communication between the processor and the three units is implemented by a request-acknowledge handshake mechanism in order to hand over argument values and wait for the requested values to return. Therefore the communication is blocking, i.e. the respective thread of control waits for their completion.

The reading/writing unit preferably implements two different operations, namely the read-operation enabling the processors 12a, 12b to read data objects from the memory and the write-operation enabling the processor 12a, 12b to write data objects into the memory 32. Each task has a predefined set of ports which correspond to the attachment points for the data streams. The arguments for these operations are an ID of the respective port ‘port_id’, an offset ‘offset’ at which the reading/writing should take place, and the variable length of the data objects ‘n_bytes’. The port is selected by a ‘port_id’ argument. This argument is a small non-negative number having a local scope for the current task only.

The synchronisation unit implements two operations for synchronisation to handle local blocking conditions on reading from an empty FIFO or writing to an full FIFO. The first operation, i.e. the getspace operation, is a request for space in the memory implemented as a FIFO and the second operation, i.e. a putspace operation, is a request to release space in the FIFO. The arguments of these operations are the ‘port_id’ and ‘n-bytes’ variable length.

The getspace operations and putspace operations are performed on a linear tape or FIFO order of the synchronisation, while inside the window acquired by the said the operations, random access read/write actions are supported.

The task switching unit implements the task switching of the processor as a gettask operation. The arguments for these operations are ‘blocked’, ‘error’, and ‘task_info’.

The argument ‘blocked’ is a Boolean value which is set true if the last processing step could not be successfully completed because a getspace call on an input port or an output port has returned false. Accordingly, the task scheduling unit is quickly informed that this task should better not be rescheduled unless a new ‘space’ message arrives for the blocked port. This argument value is considered to be an advice only leading to an improved scheduling but will never affect the functionality. The argument ‘error’ is a Boolean value which is set true if during the last processing step a fatal error occurred inside the coprocessor. Examples from mpeg decode are for instance the appearance of unknown variable-length codes or illegal motion vectors. If so, the shell clears the task table enable flag to prevent further scheduling and an interrupt is sent to the main CPU to repair the system state. The current task will definitely not be scheduled until the CPU interacts through software.

The operations just described above are initiated by read calls, write calls, getspace calls, putspace calls or gettask calls from the processor.

FIG. 4 depicts an illustration of the process of reading and writing and its associated synchronisation operations. From the processor point of view, a data stream looks like an infinite tape of data having a current point of access. The getspace call issued from the processor asks permission for access to a certain data space ahead of the current point of access as depicted by the small arrow in FIG. 4a. If this permission is granted, the processor can perform read and write actions inside the requested space, i.e. the framed window in FIG. 4b, using variable-length data as indicated by the n_bytes argument, and at random access positions as indicated by the offset argument.

If the permission is not granted, the call returns false. After one or more getspace calls—and optionally several read/write actions—the processor can decide if is finished with processing or some part of the data space and issue a putspace call. This call advances the point-of-access a certain number of bytes, i.e. n_bytes2 in FIG. 4d, ahead, wherein the size is constrained by the previously granted space.

The method to general processing steps according to the preferred embodiment as shown in FIG. 2 can also be performed on the basis of the data processing system according to FIG. 3. The main difference is that the shells 22 of the respective processors 12 in FIG. 3 take over control of the communication between the processors and the memory.

Accordingly, in FIG. 2 a flow chart the principal processing of the processor 12a, 12b is shown. In step S1 the processor performs the gettask call directed to the task scheduling unit in the shell 22 of said processor 12, in order to determine with which task it is supposed to continue. In step S2, the processor receives from its associated shell 22 or more precisely from the task scheduling unit of said shell 22, the respective information about the next task to be processed. Thereafter, in step S3 the processing continues with checking input streams belonging to the associated task to be processed next in order to decide whether sufficient data or other processing resources are available to perform the requested processing. This initial investigation may involve attempts to read some partial input and also decoding of packet headers. If it is determined in step S4 that the processing can continue since all necessary processing resources are at hand, the flow jumps to step S5 and the respective processor 12 continues with processing the current task. After the processor 12 has finished this processing in step S6 the flow will jump to the next processing step and the above-mentioned steps will be repeated.

However, if in step S4 it is determined that the processor 12 can not continue with the processing of the current task, i.e. it can not complete the current processing step, due to insufficient processing resources like a lack of data in one of the input streams, the flow will be forwarded to step S7 and all results of the partial processing done so far will be discarded without any state saving, i.e. without any saving of the partial processing results processed so far in this processing step. The partial processing may include some getspace calls, data read operations, or some processing on the acquired data. Thereafter, in step S8 the flow will be directed to restart and fully re-do the unfinished processing step at a later stage. However, abandoning the current task and discarding the partial processing results will only be possible as long as the current task did not commit any of its stream actions by sending the synchronisation message.

FIG. 5 depicts an illustration of the cyclic FIFO memory. Communicating a stream of data requires a FIFO buffer, which preferably has a finite and constant size. Preferably, it is pre-allocated in memory, and a cyclic addressing mechanism is applied for proper FIFO behaviour in the linear memory address range.

A rotation arrow 50 in the centre of FIG. 5 depicts the direction on which getspace calls from the processor confirm the granted window for read/write, which is the same direction in which putspace calls move the access points ahead. The small arrows 51, 52 denote the current access points of tasks A and B. In this example A is a writer and hence leaves proper data behind, whereas B is a reader and leaves empty space (or meaningless rubbish) behind. The shaded region (A1, B1) ahead of each access point denote the access window acquired through getspace operation.

Tasks A and B may proceed at different speeds, and/or may not be serviced for some periods in time due to multitasking. The shells 22a, 22b provide the processors 12a, 12b on which A and B run with information to ensure that the access points of A and B maintain their respective ordering, or more strictly, that the granted access windows never overlap. It is the responsibility of the processors 12a, 12b to use the information provided by the shell 22a, 22b such that overall functional correctness is achieved. For example, the shell 22a, 22b may sometimes answer a getspace requests from the processor false, e.g. due to insufficient available space in the buffer. The processor should then refrain from accessing the buffer according to the denied request for access.

The shells 22a, 22b are distributed, such that each can be implemented close to the processor 12a, 12b that it is associated to. Each shell 22a, 22b locally contains the configuration data for the streams which are incident with tasks mapped on its processor, and locally implements all the control logic to properly handle this data. Accordingly, a local stream table is implemented in the shells 22a, 22b that contains a row of fields for each stream, or in other words, for each access point.

To handle the arrangement of FIG. 5, the stream table of the processor shells 22a, 22b of tasks A and B each contain one such line, holding a ‘space’ field containing a (maybe pessimistic) distance from its own point of access towards the other point of access in this buffer and an ID denoting the remote shell with the task and port of the other point-of-access in this buffer. Additionally, said local stream table may contain a memory address corresponding to the current point of access and the coding for the buffer base address and the buffer size in order to support cited address increments.

These stream tables are preferably memory mapped in small memories, like register files, in each of said shells 22. Therefore, a getspace call can be immediately and locally answered by comparing the requested size with the available space locally stored. Upon a putspace call this local space field is decremented with the indicated amount and a putspace message is sent to the another shell which holds the previous point of access to increment its space value. Correspondingly, upon reception of such a put message from a remote source the shell 22 increments the local field. Since the transmission of messages between shells takes time, cases may occur where both space fields do not need to sum up to the entire buffer size but might momentarily contain the pessimistic value. However this does not violate synchronisation safety. It might even happen in exceptional circumstances that multiple messages are currently on their way to destination and that they are serviced out of order but even in that case the synchronisation remains correct.

FIG. 6 shows a mechanism of updating local space values in each shell and sending ‘putspace’ messages. In this arrangement, a getspace request, i.e. the getsspace call, from the processor 12a, 12b can be answered immediately and locally in the associated shell 22a, 22b by comparing the requested size with the locally stored space information. Upon a putspace call, the local shell 22a, 22b decrements its space field with the indicated amount and sends a putspace message to the remote shell. The remote shell, i.e. the shell of another processor, holds the other point-of-access and increments the space value there. Correspondingly, the local shell increments its space field upon reception of such a putspace message from a remote source.

The space field belonging to point of access is modified by two sources: it is decrement upon local putspace calls and increments upon received putspace messages. It such an increment or decrement is not implemented as atomic operation, this could lead to erroneous results. In such a case separated local-space and remote-space field might be used, each of which is updated by the single source only. Upon a local getspace call these values are then subtracted. The shells 22 are always in control of updates of its own local table and performs these in an atomic way. Clearly this is a shell implementation issue only, which is not visible to its external functionality.

If getspace call returns false, the processor is free to decide an how to react. Possibilities are, a) the processor my issue a new getspace call with a smaller n_bytes argument, b) the processor might wait for a moment and then try again, or c) the processor might quit the current task and allow another task on this processor to proceed.

This allows the decision for task switching to depend upon the expected arrival time of more data and the amount of internally accumulated state with associated state saving cost. For non-programmable dedicated hardware processors, this decision is part of the architectural design process.

The implementation and operation of the shells 22 do not to make differentiations between read versus write ports, although particular instantiations may make these differentiations. The operations implemented by the shells 22 effectively hide implementation aspects such as the size of the FIFO buffer, its location in memory, any wrap-around mechanism on address for memory bound cyclic FIFO's, caching strategies, cache coherency, global I/O alignment restrictions, data bus width, memory alignment restrictions, communication network structure and memory organisation.

Preferably, the shell 22a, 22b operate on unformatted sequences of bytes. There is no need for any correlation between the synchronisation packet sizes used by the writer and a reader which communicate the stream of data. A semantic interpretation of the data contents is left to the processor. The task is not aware of the application graph incidence structure, like which other tasks it is communicating to and on which processors these tasks mapped, or which other tasks are mapped on the same processor.

In high-performance implementations of the shells 22 the read call, write call, getspace call, putspace calls can be issued in parallel via the read/write unit and the synchronisation unit of the shells 22a, 22b. Calls acting on the different ports of the shells 22 do not have any mutual ordering constraint, while calls acting on identical ports of the shells 22 must be ordered according to the caller task or processor. For such cases, the next call from the processor can be launched when the previous call has returned, in the software implementation by returning from the function call and in hardware implementation by providing an acknowledgement signal.

A zero value of the size argument, i.e. n_bytes, in the read call can be reserved for performing pre-fetching of data from the memory to the shells cache at the location indicated by the port_ID- and offset-argument. Such an operation can be used for automatic pre-fetching performed by the shell. Likewise, a zero value in the write call can be reserved for a cache flush request although automatic cache flushing is a shell responsibility.

Optionally, all five operations accept an additional last task_ID argument. This is normally the small positive number obtained as result value from an earlier gettask call. The zero value for this argument is reserved for calls which are not task specific but relate to processor control.

In the preferred embodiment the set-up for communication a data stream is a stream with one writer and one reader connected to the finite-size of FIFO buffer. Such a stream requires a FIFO buffer which has a finite and constant size. It will be pre-allocated in memory and in its linear address range is cyclic addressing mechanism is applied for proper FIFO behaviour.

However in a further embodiment based on FIG. 3 and FIG. 7, the data stream produced by one task is to be consumed by two or more different consumers having different input ports. Such a situation can be described by the term forking. However, we want to re-use the task implementations both for multi-tasking hardware processors as well as for software task running on the CPU. This is implemented through tasks having a fixed number of ports, corresponding to their basic functionality and that any needs for forking induced by application configuration are to be resolved by the shell.

Clearly stream forking can be implemented by the shells 22 by just maintaining two separate normal stream buffers, by doubling all write and putspace operations and by performing an AND-operation on the result values of doubled getspace checks. Preferably, this is not implemented as the costs would include a double write bandwidth and probably more buffer space. Instead preferably, the implementation is made with two or more readers and one writer sharing the same FIFO buffer.

FIG. 7 shows an illustration of the FIFO buffer with a single writer and multiple readers. The synchronisation mechanism must ensure a normal pair wise ordering between A and B next to a pair wise ordering between A and C, while B and C have no mutual constraints, e.g. assuming they are pure readers. This is accomplished in the shell associated to the processor performing the writing operation by keeping track of available space separately for each reader (A to B and A to C). When the writer performs a local getspace call its n_bytes argument is compared with each of these space values. This is implemented by using extra lines in said stream table for forking connected by one extra field or column to indicate changing to a next line.

This provides a very little overhead for the majority of cases where forking is not used and at the same time does not limit forking to two-way only. Preferably, forking is only implemented by the writer and the readers are not aware of this situation.

In a further embodiment based on FIG. 3 and FIG. 8, the data stream is realised as a three station stream according to the tape-model. Each station performs some updates of the data stream which passes by. An example of the application of the three station stream is one writer, and intermediate watchdog and the final reader. In such example of the second task preferably watches the data that passes and may be inspects some while mostly allowing the data to pass without modification. Relatively infrequently it could decide to change a few items or data objects in the stream. This can be achieved efficiently by in-place buffer updates by a processor to avoid copying the entire stream contents from one buffer to another. In practice this might be useful when hardware processors 12 communicate and the main CPU 11 intervenes to modify the stream to correct hardware flaws, to do adaptation towards slightly different stream formats, or just for debugging reasons. Such a set-up could be achieved with all three processors sharing the single stream buffer in memory, to reduce memory traffic and processor workload. The task B will not actually read or write the full data stream.

FIG. 8 depicts a finite memory buffer implementation for a three-station stream. The proper semantics of this three-way buffer include maintaining a strict ordering of A, B and C with respect to each other and ensuring no overlapping windows. In this way the three-way buffer is a extension from the two-way buffer shown in FIG. 5. Such a multi-way cyclic FIFO is directly supported by the operations of the shells as described above as well as by the distributed implementation style with putspace messages as discussed in the preferred embodiment. There is no limitation to just three stations in a single FIFO. In-place processing where one station both consumes and produces useful data is also applicable with only two stations. In this case both tasks performing in-place processing to exchange data with each other and no empty space is left in the buffer.

In another embodiment based on the preferred embodiment of FIG. 2, the idea of the logical separation of read/write operations and synchronisation operations is implemented as a physical separation of the data transport, i.e. the read and a write operations, and the synchronisation. Preferably, a wide bus allowing high bandwidths for the transport, i.e. the read/write operations of data, is implemented. A separate communication network is implemented for the synchronisation operations, since it did not appeared preferable to use the same wide bus for synchronisation. This arrangement has the advantage that both networks can be optimised for their respective use. Accordingly, the data transport network is optimised for memory I/O, i.e. the reading and writing operations, and the synchronisation network is optimised for inter-processor messages.

The synchronisation network is preferably implemented as a message passing ring network, which is especially tuned and optimised for this purpose. Such a ring network is small and very scalable supporting the flexibility requirement of a scalable architecture. The higher latency of the ring network does not influence the performance of the network negatively as the synchronisation delays are absorbed by the data stream buffers and memories. The total throughput of the ring the network is quite high and each link in the ring can pass a synchronisation message simultaneously allowing as many messages in-flight as there are processors.

In still another embodiment based on FIG. 3, the idea of the physical separation of the data transport and synchronisation is realised. The synchronisation units in the shell 22a are connected to other synchronisation units in another shell 22b. The synchronization units ensures that one processor does not access memory locations before valid data for a processed stream has been written to these memory locations. Similarly, synchronization interface is used to ensure that the processor 12a does not overwrite useful data in memory 32. Synchronization units communicate via a synchronization message network. Preferably, they form part of a ring, in which synchronization signals are passed from one processor to the next, or blocked and overwritten when these signals are not needed at any subsequent processor. The synchronization units together form a synchronization channel. The synchronization unit maintain information about the memory space which is used for transferring the stream of data objects from processor 12a to processor 12b.

1. Method for processing data in a data processing system, said system comprising a first and at least a second processor for processing streams of data objects, said first processor being arranged to pass data objects from a stream of data objects to the second processor; and at least one memory for storing and retrieving data objects, wherein a shared access for said first and said second processors is provided, said method comprising the steps of:
said processors perform read operations and/or write operations to exchange data objects with said memory; and
said processors perform inquiry operations and/or commit operations to synchronise data object transfers between tasks which are executed by said processors;
wherein said inquiry operations and said commit operations are performed by said processors independently of said read operations and said write operations.

2. Method according to claim 1, wherein
said inquiry operations are executed by one of said second processors to request the right to access a group of data objects in said memory, wherein said group of data objects is produced or consumed in said memory by a series of read/write operations by said processors; and
said commit operations are executed by one of said second processors to transfer the right to access said group of data objects to another of said second processors.

3. Method according to claim 1, wherein
said memory is a FIFO buffer, and
said inquiry and commit operations are used to control the FIFO behaviour of said memory buffer in order to transport streams of data objects between said first and second processors through said shared memory buffer.

4. Method according to claim 1, wherein
a third processor receives the right to access a group of data objects from said first processor, performs read and/or write operations on said group of data objects, and transfers the right of access to said second processor, without copying said group of data objects to another location in said shared memory.

5. Method according to claim 1, wherein
said second processor is a multi-tasking processor, capable of interleaved processing of at least a first and second tasks, wherein said at least a first and second tasks process streams of data objects.

6. Method according to claim 1, wherein
said second processors being function-specific dedicated processors for performing a range of stream processing tasks.

7. Method according to claim 2, wherein
said read/write operations enable said second processors to randomly access locations within one of said groups of data objects in said memory.

8. Method according to claim 1, wherein
the further processing of a group of data object of a first task is temporarily prevented, when the processing of said group of data objects is interrupted,
wherein processing of data objects of a second task is carried out when processing of said group of data elements of said first task is interrupted.

9. Method according to claim 8, wherein
after the interruption of the task the actual task state of the partial processing of the group of data objects is discarded and commit operation of the partial group of data objects is prevented.

10. Method according to claim 7, wherein
after resumption of the interrupted task, the processor restarts the processing of the group of data objects, whereby previous processing on said group is discarded.

11. A data processing system, comprising:
a first and at least a second processor for processing streams of data objects, said first processor being arranged to pass data objects from a stream of data objects to the second processor; and
at least one memory for storing and retrieving data objects, wherein a shared access for said first and said second processors is provided,
said processors being adopted to perform read operations and/or write operations to exchange data objects with said memory; and
said processors being adopted to perform inquiry operations and/or commit operations to synchronise data object transfers between tasks which are executed by said processors;
wherein said processors being adopted to perform said inquiry operations and said commit operations independently of said read operations and said write operations.

12. A data processing system according to claim 11, wherein
said second processor being adapted to execute said inquiry operations to request the right to access a group of data objects in said memory, wherein said group of data objects is produced or consumed in said memory by a series of read/write operations by said processors; and
said second processor being adapted to execute said commit operations to transfer the right to access said group of data objects to another of said second processors.

13. A data processing system according to claim 11, wherein
said memory is a FIFO buffer, and
said processors being adopted to perform said inquiry and commit operations in order to control the FIFO behaviour of said memory buffer for transporting streams of data objects between said first and second processors through said shared memory buffer.

14. A data processing system according to claim 11, comprising
a third processor being adapted to receive the right to access a group of data objects from said first processor, to perform read and/or write operations on said group of data objects, and to transfer the right of access to said second processor, without copying said group of data objects to another location in said shared memory.

15. Data processing system according to claim 11, wherein said second processor is the multi-tasking processor, capable of interleaved processing of at least a first and second tasks, wherein said at least a first and second tasks process streams of data objects.

16. Data processing system according to claim 11, wherein said second processors being function-specific dedicated processors for performing a range of stream processing tasks.

17. Data processing system according to claim 12, wherein said second processors is adopted to perform read and/or write operations enabling to randomly access locations within one of said groups of data objects in said memory.

18. Data processing system according to claim 11, wherein
the further processing of a group of data object of a first task is temporarily prevented, when the processing of said group of data objects is interrupted,
wherein processing of data objects of a second task is carried out when processing of said group of data elements of said first task is interrupted.

19. Data processing system according to claim 18, wherein
after the interruption of the task the actual task state of the partial processing of the group of data objects is discarded and commit operation of the partial group of data objects is prevented.

20. Data processing system according to claim 19, wherein
after resumption of the interrupted task, the processor restarts the processing of the group of data objects, whereby previous processing on said group is discarded.
